(19) United States
(12) Patent Application Publication
(10) Pub. No.: US 2023/0300133 A1
(43) Pub. Date: Sep. 21, 2023

(54) OPTICAL COMMUNICATION BASED HOUSEHOLD APPLIANCE COMMISSIONING

(71) Applicant: Haier US Appliance Solutions, Inc., Wilmington, DE (US)

(72) Inventors: James Hyongsup Kim, Louisville, KY (US); Olivia Laine Alford, South Bend, IN (US)

(21) Appl. No.: 17/699,520

(22) Filed: Mar. 21, 2022

(51) Int. Cl. H04L 9/40; H04B 10/112

(52) U.S. Cl. CPC H04L 63/0892; H04B 10/112; H04L 63/102

(57) ABSTRACT

A method of commissioning a household appliance includes establishing an optical communications link to the household appliance by physically positioning the household appliance in alignment with an optical element. The method also includes receiving network credentials, by the household appliance, via the optical communications link. The method further includes connecting, by the household appliance, to a wireless network using the received network credentials and associating the household appliance with a user account in a remote database.

### FIELD OF THE INVENTION

The present subject matter relates generally to household appliances which can connect to a home network and/or a remote network such as the internet. In particular, the present subject matter relates to a household appliance configured for improved commissioning of the household appliance to a user account and related methods.

### BACKGROUND OF THE INVENTION

Household appliances are utilized generally for a variety of tasks by a variety of users. For example, a household may include such appliances as laundry appliances, e.g., a washer and/or dryer, kitchen appliances, e.g., a refrigerator, a microwave, and/or a coffee maker, along with room air conditioners and other various appliances.

Some household appliances can also include features for connecting to and communicating over a secure wireless network. Such communication may provide connected features on the household appliance, e.g., where the household appliance communicates with a personal device, smart home systems, and/or a remote database such as a cloud server.

Typically, such household appliances require multiple processes using multiple user interfaces in order to establish a connection or association, in particular an initial connection or association, between the household appliance and a user account.

Accordingly, there exists a need for an appliance which can be commissioned, e.g., connected to a secured wireless network and added to a user account, in an easier and more convenient manner.

### BRIEF DESCRIPTION OF THE INVENTION

Aspects and advantages of the invention will be set forth in part in the following description, or may be obvious from the description, or may be learned through practice of the invention.

In accordance with one embodiment of the present disclosure, a method of commissioning a new household appliance using an existing household appliance is provided. The existing household appliance is connected to a wireless network and commissioned to a user account. The method includes establishing an optical communications link between the existing household appliance and the new household appliance by physically aligning respective optical elements of the existing household appliance and the new household appliance with each other. The method also includes transmitting network credentials for the wireless network from the existing household appliance to the new household appliance via the optical communications link. The method further includes connecting, by the new household appliance, to the wireless network using the transmitted network credentials and associating the new household appliance with the user account in a remote database.

In accordance with another embodiment of the present disclosure, a method of commissioning a household appliance is provided. The method includes establishing an optical communications link to the household appliance by physically positioning the household appliance in alignment with an optical element. The method also includes receiving network credentials, by the household appliance, via the optical communications link. The method further includes connecting, by the household appliance, to a wireless network using the received network credentials and associating the household appliance with a user account in a remote database.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a partially exploded perspective view of an exemplary first appliance in accordance with one or more example embodiments of the present disclosure.

FIG. 2 provides a perspective view of an exemplary second appliance in accordance with one or more example embodiments of the present disclosure.

FIG. 3 provides a section view of the appliance of FIG. 2 taken along line 3-3 of FIG. 2.

FIG. 4 provides a schematic view of a first appliance and a second appliance in optical communication with each other, where the second appliance is an already-commissioned appliance, in accordance with one or more example embodiments of the present disclosure.

FIG. 5 provides a schematic view of a first appliance and a second appliance in optical communication with each other, where the first appliance is an already-commissioned appliance, in accordance with one or more example embodiments of the present disclosure.

FIG. 6 provides a flowchart illustrating an example method of commissioning a household appliance according to one or more example embodiments of the present disclosure.

FIG. 7 provides a flowchart illustrating another example method of commissioning a household appliance according to one or more additional example embodiments of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, terms of approximation, such as “generally,” or “about” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

In accordance with one or more embodiments of the present subject matter, a group of appliances including at least a first appliance 10 and a second appliance 11 is provided. As will be described in more detail below, the first appliance 10 is a relatively small and light appliance, such that the first appliance 10 may be considered a portable appliance in that the first appliance 10 may be easily picked up and moved to the second appliance 11, whereas the second appliance 11 may be a larger and/or heavier appliance or a built-in appliance, such that the second appliance 11 is not readily moved, e.g., lifted, by a single person without tools such as a dolly or hand truck. Thus, the second appliance 11 may be considered a stationary appliance. In other embodiments, both appliances may be relatively small and light, such that both appliances may be considered portable appliances.

Accordingly, one appliance, e.g., the first appliance 10 or portable appliance, may be brought into contact or close proximity, such as within about one foot or less, with the other appliance, e.g., the second appliance 11 (where the other appliance, e.g., second appliance 11, may be but is not necessarily a stationary appliance) in order to establish an optical communication link between the one appliance and the other appliance. The optical communication link may then be used to commission the one appliance or the other appliance to a secure network and/or a user account.

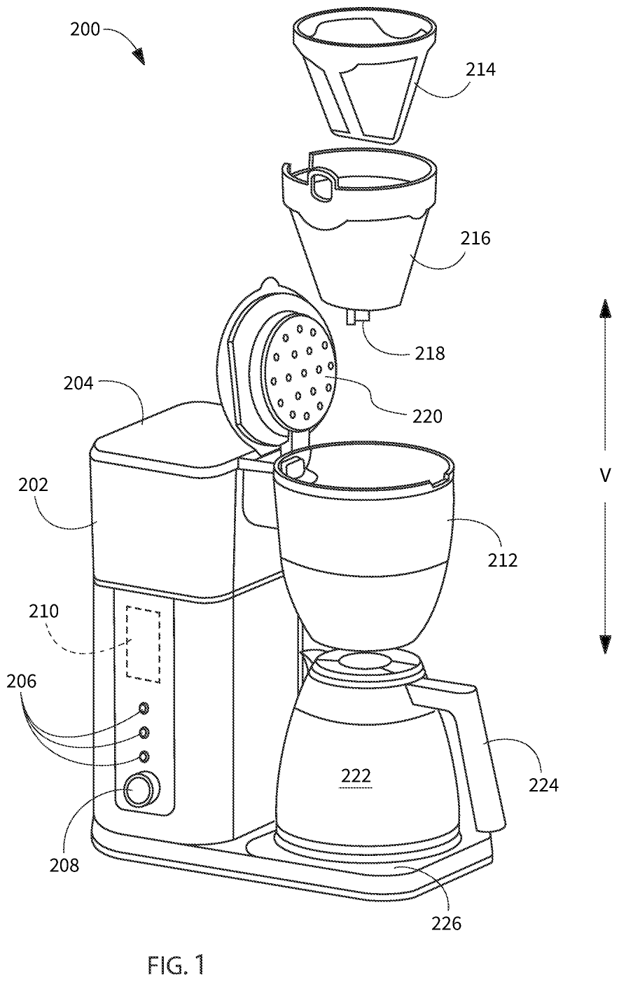

FIG. 1 provides a partially exploded perspective view of an exemplary coffee making appliance 200 (sometimes also referred to as a coffee maker) which may be considered a portable appliance, and which may be an embodiment of a first appliance according to one or more embodiments of the present subject matter. Other exemplary appliances which may be considered portable as used in the present disclosure include countertop appliances such as a standalone ice maker, e.g., an OPAL™ ice maker, or various other household appliances of a similar size or smaller. For example, “portable appliance” or “portable appliances” as used herein may also include a water leak alarm.

As illustrated in FIG. 1, the coffee making appliance 200 defines a vertical direction V. In various exemplary embodiments, the coffee making appliance 200 may include a water tank or reservoir 202 which is open at a top end thereof and is selectively enclosed by a reservoir lid 204. The reservoir lid 204 may be rotatably mounted, e.g., by one or more hinges, to the top end of the reservoir 202 to selectively rotate between a closed position (e.g., as illustrated in FIG. 1) where the reservoir 202, and in particular the open top end thereof, is enclosed by the lid 204 and an open position (not shown) permitting access to the reservoir 202, e.g., so that a user may fill the reservoir with water for coffee brewing. Water in the reservoir 202 may be drawn from the reservoir to a brew basket 212 by a pump (not shown).

In some embodiments, the coffee making appliance 200 may also include a filter 214, e.g., a mesh basket filter as in the example embodiment illustrated in FIG. 1, and a brew basket insert 216. As illustrated in FIG. 1, the filter 214 and the brew basket insert 216 are configured, e.g., sized and shaped, for nesting engagement with each other and with the brew basket 212. In particular, the filter 214 may be configured to fit within the brew basket insert 216 and the brew basket insert 216 may be configured to fit within the brew basket 212, e.g., with the filter 214 disposed within the brew basket insert 216 while the insert 216 is positioned within the brew basket 212. Thus, the filter 214 may receive coffee grounds for brewing and the filter 214, e.g., with grounds therein, may be received within the brew basket insert 216 while the brew basket insert 216 is received within the brew basket 212.

The coffee maker appliance 200 may further include a shower head 220 which is configured to be disposed above the brew basket 212 along the vertical direction V for providing a flow of, e.g. water, from the reservoir 202 to the brew basket 212, and in particular to the brew basket insert 216, the filter 214, and coffee grounds disposed therein, which are nested within the brew basket 212 as described above. In particular, the shower head 220 may receive the flow of water from the reservoir 202 via the pump. In various embodiments, the pump may be or include any suitable device for motivating the liquid, e.g., water, from the reservoir 202 to the shower head 220. For example, in some embodiments, the pump may be a mechanical pump including an impeller (not shown) which motivates the liquid into and/or through the pump. In additional example embodiments, the coffee maker appliance 200 may include a heater (not shown) which may also or instead motivate the liquid, e.g., in addition to or instead of the separate pump, such as by heating the water until it expands into and through a conduit upstream of the shower head 220 and ultimately to the shower head 220 itself.

The shower head 220 is configured to provide a drip flow of water to the brew basket 212, e.g., the shower head 220 may include a plurality of outlets in order to form a slow, diffuse flow of water which is evenly distributed across the horizontal cross-sectional area of the brew basket 212. In additional embodiments, other suitable nozzle or spout configurations for providing and directing the flow of water from the reservoir 202 into the brew basket 212 may be provided as well as or instead of the shower head 220, such as a plurality of discrete nozzles (in contrast to the multiple outlets formed in the single unitary body of the shower head 220 as illustrated FIG. 1), among other possible example embodiments.

A thermal carafe 222 may be removably positioned below the brew basket 212 along the vertical direction V. The coffee making appliance 200 may include a hot plate 226 which is configured to provide thermal energy to the carafe 222 and contents thereof when the carafe 222 is positioned below the brew basket 212 and on top of the hot plate 226, e.g., as illustrated in FIG. 1. With the thermal carafe 222 so positioned, the thermal carafe 222 may receive a flow of liquid, e.g., coffee, from the brew basket 212 by gravity. The thermal carafe 222 may include a handle 224 which a user may grasp, e.g., in order to place the carafe 222 on the hot plate 226 and below the brew basket 212 and/or to remove the carafe 222 therefrom in order to access liquid coffee in the carafe 222, e.g., the liquid coffee may be poured from the carafe 222 into a suitable container for consumption, such as a mug or thermos, etc. The handle 224 may be formed of a thermally insulating material, e.g., plastic, and may thereby provide a cool, safe touch surface or surfaces for the user.

As may be seen in FIG. 1, the brew basket insert 216 may include a drip stop lever 218, e.g., which actuates a valve to open the valve and thereby permit liquid flow from the brew basket 212 and/or from the brew basket insert 216 into the thermal carafe 222. For example, the drip stop lever 218 may be configured to extend from the brew basket 212, e.g., below the brew basket 212 along the vertical direction V, when the brew basket insert 216 is received within the brew basket 212. Thus, when the thermal carafe 222 is positioned below the brew basket 212 and aligned with the brew basket 212 to receive the liquid flow therefrom, the thermal carafe 222 may engage the drip stop lever 218, e.g., may push the drip stop lever 218 upward along the vertical direction V, to thereby open the valve and permit liquid, e.g., coffee, flow from the brew basket 212 into the carafe 222, e.g., by gravity as mentioned above.

Referring still to FIG. 1, in some embodiments, one or more selector inputs, such as buttons 206, one or more knobs 208, a touchpad, or touchscreen interfaces, etc., may be provided or mounted on the coffee making appliance 200, e.g., on a control panel thereof and are in operable communication (e.g., electrically coupled or coupled through a wireless network band) with a processing device or controller 210 of the coffee making appliance 200, such as via one or more signal lines or shared communication busses. In response to user manipulation of the selector inputs, controller 210 operates the various components of coffee making appliance 200 to execute selected cycles and features. The control panel may also include a display. The controller 210 may also be provided in operable communication with various components of the coffee making appliance, such as the pump, hot plate 226, etc., as well as one or more sensors such as temperature sensors, e.g., thermocouples, thermistors, or other suitable temperature sensors. In turn, signals generated in controller 210 direct operation of such components in response to the inputs 206 and/or 208. As used herein, “processing device” or “controller” may refer to one or more microprocessors, microcontroller, ASICS, or semiconductor devices and is not restricted necessarily to a single element. The controller 210 may be programmed to operate coffee making appliance 200 by executing instructions stored in memory (e.g., non-transitory media). The controller 210 may include, or be associated with, one or more memory elements such as RAM, ROM, or electrically erasable, programmable read only memory (EEPROM). In one embodiment, the processor executes programming instructions stored in memory. The memory may be a separate component from the processor or may be included onboard within the processor. For example, the instructions may be software or any set of instructions that when executed by the processing device, cause the processing device to perform operations. It should be noted that controllers as disclosed herein are capable of and may be operable to perform any methods and associated method steps as disclosed herein. For example, in some embodiments, methods disclosed herein may be embodied in programming instructions stored in the memory and executed by the controller 210.

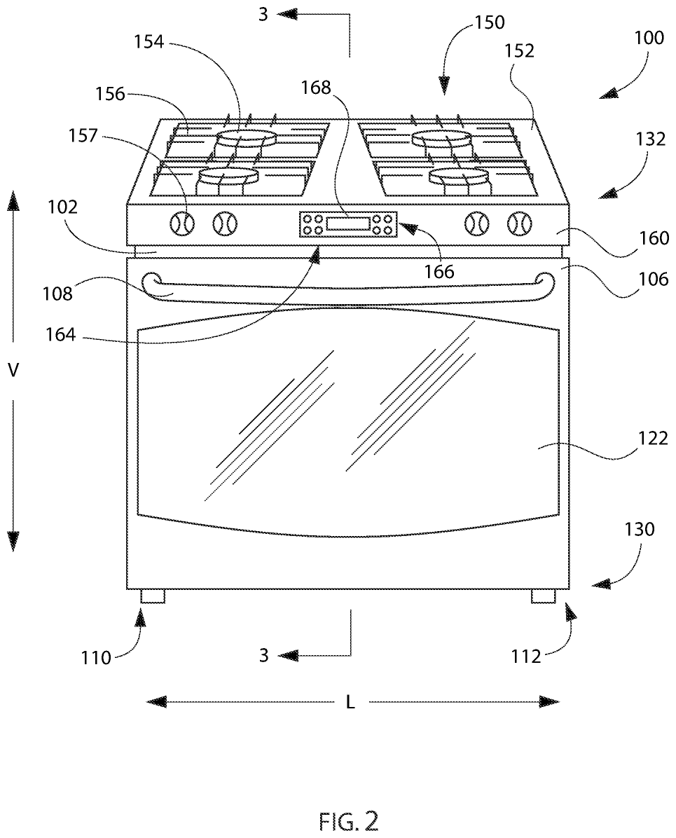

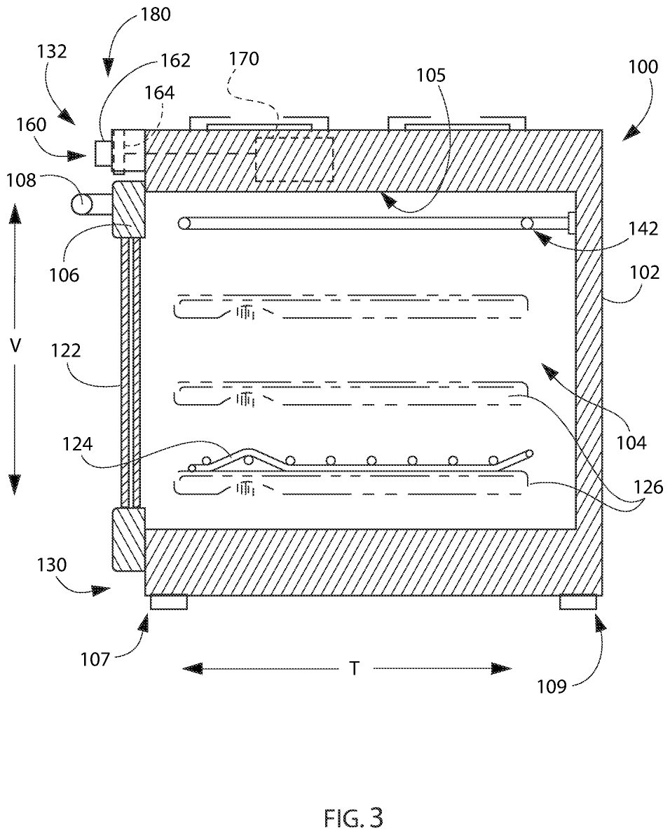

FIGS. 2 and 3 illustrate an exemplary oven appliance 100, which may be considered a stationary appliance, and which may be an embodiment of a second appliance according to one or more embodiments of the present subject matter. Other exemplary appliances which may be considered stationary as used in the present disclosure include appliances such as a refrigerator appliance, a dishwasher appliance, laundry appliances such as a washer and/or dryer, a water heater, etc., and other appliances which are not readily transported by a single individual due to their size, weight, and/or being generally fixed in place by one or more mechanical, electrical, and/or plumbing connections.

FIG. 2 provides a front perspective view of an oven appliance 100 according to exemplary embodiments of the present subject matter. FIG. 3 provides a section view of exemplary oven appliance 100 taken along line 3-3 of FIG. 2. Oven appliance 100 is shown in FIGS. 2 and 3 as a free-standing range oven appliance, but it will be appreciated that oven appliance 100 is provided by way of example only and is not intended to limit the present subject matter in any aspect. Thus, the present subject matter may be used with other oven appliance configurations, e.g., a cooktop appliance and/or oven appliances that define one or more interior cavities for the receipt of food items and/or having different pan or rack arrangements than what is shown in FIG. 3, among numerous other possible variations within the scope of the present disclosure.

Oven appliance 100 includes an insulated cabinet 102 with an interior cooking chamber 104 defined by an interior surface 105 of cabinet 102. Cooking chamber 104 is configured for receipt of one or more food items to be cooked. Cabinet 102 extends between a bottom portion 130 and a top portion 132 along a vertical direction V. Cabinet 102 also extends between a front portion 107 and a back portion 109 along a transverse direction T and between a first side 110 and a second side 112 along a lateral direction L. The first side 110 may be a left side and the second side 112 may be a right side, e.g., from the perspective of a user standing in front of the oven appliance 100, such as to access the user inputs 166 and/or door 106. The vertical direction V, the lateral direction L, and the transverse direction T are mutually perpendicular and form an orthogonal direction system.

Oven appliance 100 includes a door 106 rotatably mounted to cabinet 102, e.g., with a hinge (not shown). A handle 108 is mounted to door 106 and assists a user with opening and closing door 106. For example, a user can pull or push handle 108 to open or close door 106 to access cooking chamber 104. Oven appliance 100 includes a seal (not shown) between door 106 and cabinet 102 that maintains heat and cooking fumes within cooking chamber 104 when door 106 is closed as shown in FIGS. 2 and 3. Multiple parallel glass panes 122 provide for viewing the contents of cooking chamber 104 when door 106 is closed and provide insulation for cooking chamber 104. A baking rack 124 is positioned in cooking chamber 104 for receipt of food items or utensils containing food items. Baking rack 124 is slidably received onto embossed ribs or sliding rails 126 such that rack 124 may be conveniently moved into and out of cooking chamber 104 when door 106 is open.

A top heating element or broil element 142 is positioned in cooking chamber 104 of cabinet 102 proximate top portion 132 of cabinet 102. Top heating element 142 is used to heat cooking chamber 104 for both cooking/broiling and cleaning of oven appliance 100. Like heating assembly 140, the size and heat output of top heating element 142 can be selected based on, e.g., the size of oven appliance 100. In the exemplary embodiment shown in FIG. 2, top heating element 142 is shown as an electric resistance heating element.

As shown in FIG. 2, oven appliance 100 includes a cooktop 150. Cooktop 150 is disposed on and is attached to or integral with cabinet 102. Cooktop 150 includes a top panel 152, which by way of example may be constructed of glass, ceramics, enameled steel, or combinations thereof. One or more burners 154 extend through top panel 152. A utensil (e.g., pots, pans, etc.) holding food and/or cooking liquids (e.g., oil, water, etc.) may be placed onto grates 156 disposed adjacent burners 154. Burners 154 provide thermal energy to cooking utensils placed on grates 156. Burners 154 can be any suitable type of burners, including e.g., gas, electric, electromagnetic, a combination of the foregoing, etc. It will be appreciated that the configuration of cooktop 150 is provided by way of example only and that other suitable configurations are contemplated.

Oven appliance 100 includes a user interface panel 160. For this exemplary embodiment, user interface panel 160 includes a number of knobs 162 that each correspond to one of the burners 154. Knobs 162 allow users to activate each burner 154 and to determine the amount of heat input provided by each burner 154 to a cooking utensil located thereon.

User interface panel 160 also includes a control panel 164 that provides visual information to a user and allows the user to select various operational features for the operation of oven appliance 100 via one or more user inputs 166. One or more of a variety of electrical, mechanical or electro-mechanical input devices including rotary dials, push buttons, toggle/rocker switches, and/or touch pads can also be used singularly or in combination as user inputs 166.

A display 168 of control panel 164 may present certain information to users, such as, e.g., whether a particular burner 154 is activated and/or the level at which the burner 154 is set. Display 168 can be a touch sensitive component (e.g., a touch-sensitive display screen or a touch pad) that is sensitive to the touch of a user input object (e.g., a finger or a stylus). Display 168 may include one or more graphical user interfaces that allow for a user to select or manipulate various operational features of oven appliance 100 or its cooktop 150.

Referring now specifically to FIG. 3, the operation of oven appliance 100 is controlled by a processing device or controller 170. As shown, controller 170 is communicatively coupled with control panel 164 and its user inputs 166. Controller 170 may also be communicatively coupled with various operational components of oven appliance 100 as well, such as heating assembly 140, e.g., heating element 142, knobs 162, temperature sensors, cameras, speakers, and microphones, etc. Input/output (“I/O”) signals may be routed between controller 170 and the various operational components of oven appliance 100. Thus, controller 170 can selectively activate and operate these various components. Various components of oven appliance 100 are communicatively coupled with controller 170 via one or more communication lines 172, such as, e.g., signal lines, shared communication busses, or wirelessly.

Controller 170 includes one or more memory devices and one or more processors (not labeled). The processors can be any combination of general or special purpose processors, CPUs, or the like that can execute programming instructions or control code associated with operation of oven appliance 100. The memory devices may represent random access memory such as DRAM or read only memory such as ROM or FLASH. In one embodiment, the processor executes programming instructions stored in memory. The memory may be a separate component from the processor or may be included onboard within the processor. Alternatively, controller 170 may be constructed without using a processor, e.g., using a combination of discrete analog and/or digital logic circuitry (such as switches, amplifiers, integrators, comparators, flip-flops, AND gates, and the like) to perform control functionality instead of relying upon software. Controller 170 may include a network interface such that controller 170 can connect to and communicate over one or more networks with one or more network nodes. Controller 170 can also include one or more transmitting, receiving, and/or transceiving components for transmitting/receiving communications with other devices communicatively coupled with oven appliance 100. Additionally or alternatively, one or more transmitting, receiving, and/or transceiving components can be located off board controller 170. Controller 170 can be positioned in a variety of locations throughout oven appliance 100. For this embodiment, controller 170 is located proximate user interface panel 160 toward top portion 132 of oven appliance 100. In one embodiment, the processor executes programming instructions stored in memory. The memory may be a separate component from the processor or may be included onboard within the processor. For example, the instructions may be software or any set of instructions that when executed by the processing device, cause the processing device to perform operations. It should be noted that controllers as disclosed herein are capable of and may be operable to perform any methods and associated method steps as disclosed herein. For example, in some embodiments, methods disclosed herein may be embodied in programming instructions stored in the memory and executed by the controller 170.

Control panel 164, including user inputs 166 and display 168, and knobs 162 collectively make up a user interface 180 of oven appliance 100. User interface 180 provides a means for users to communicate with and operate oven appliance 100. It will be appreciated that other components or devices that provide for communication with oven appliance 100 for operating oven appliance 100 may also be included in user interface. For example, although not shown, user interface 180 may include a speaker, a microphone, a camera or motion detection camera for detecting a user's proximity to oven appliance 100 or for picking up certain motions, and/or other user interface elements in various combinations.

According to various embodiments of the present disclosure, the appliances 10 and 11 may take the form of any of the examples described above, or may be any other household appliance where improved ease of commissioning the appliance is desired. Thus, it will be understood that the present subject matter is not limited to any particular household appliance.

It should be understood that “household appliances” and/or “appliances” are used herein to describe appliances typically used or intended for common domestic tasks, such as laundry appliances or kitchen appliances, or air conditioners, dishwashing appliances, water heaters, etc., and any other household appliance which performs similar functions in addition to network communication and data processing. Thus, devices such as a personal computer, router, and other similar devices whose primary functions are network communication and/or data processing are not considered household appliances as used herein.

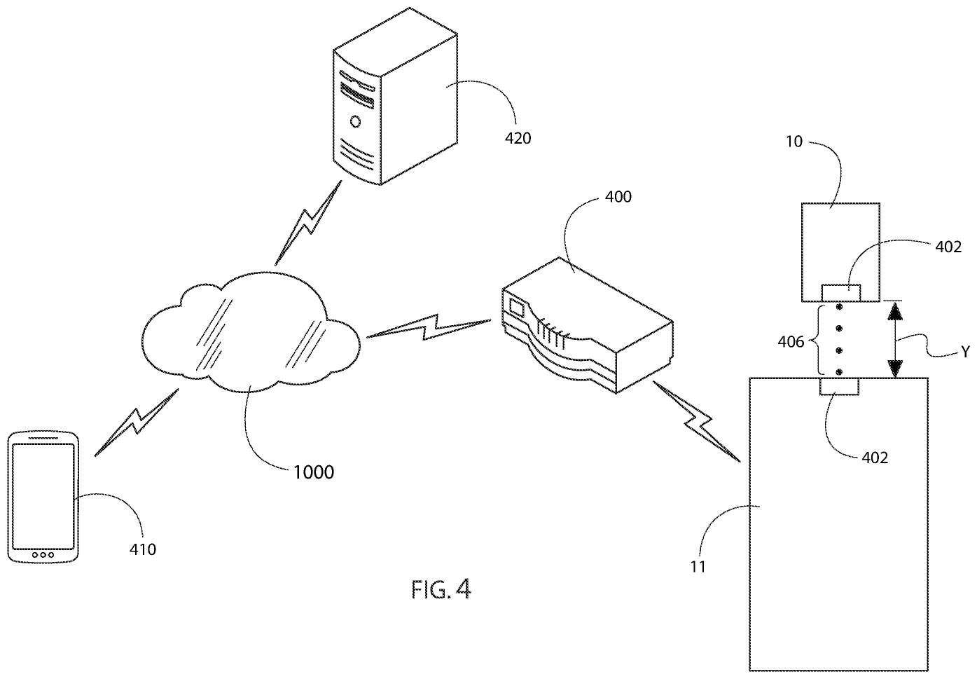

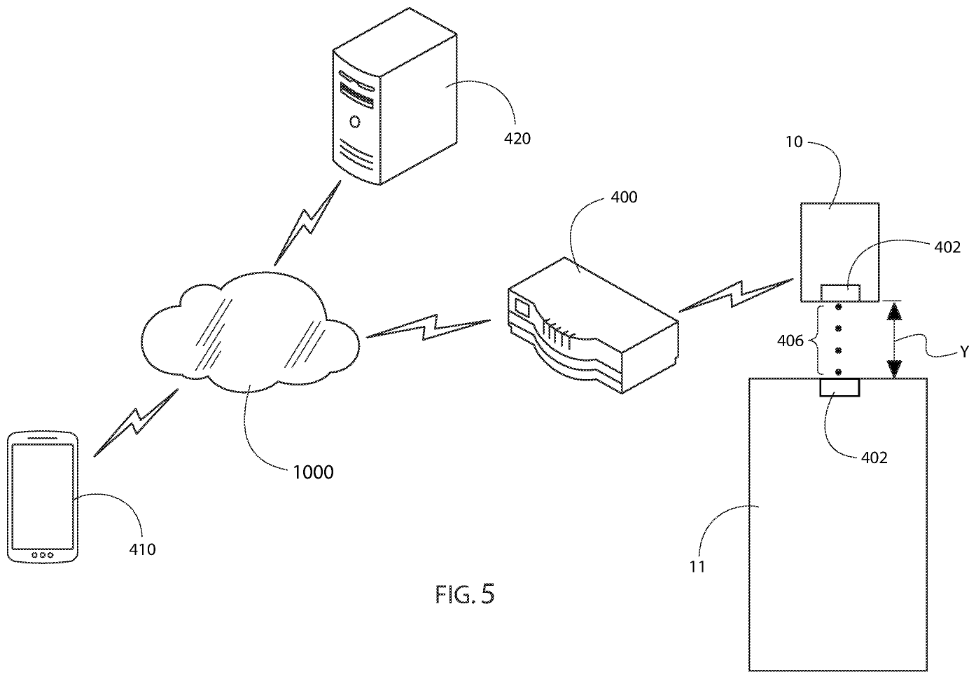

Turning now generally to FIGS. 4 and 5, the household appliances 10 and 11 may be configured to communicate with each other, e.g., in at least some embodiments, the household appliances 10 and 11 may connect directly and communicate directly, e.g., without an intervening device or communication hub. For example, the household appliances 10 and 11 may each include an optical element, such as an optical transceiver 402. Each optical element, e.g., optical transceiver 402, may be communicatively and operatively coupled with the controller, e.g., controller 210 or 170, of the respective household appliance 10 and 11. The household appliances 10 and 11 may be communicatively coupled by an optical communications link 406 established by and between the respective optical transceivers 402. For example, the optical communications link 406 may include infrared (IR) signals transmitted from and received by each household appliance 10 and 11, such as by the optical transceivers 402 thereof.

The optical communications link 406 may be established by physically placing the appliances 10 and 11 in contact with each other or within a close distance of each other and with the optical transceivers 402 thereof mutually aligned. For example, as illustrated in FIGS. 4 and 5, the household appliances 10 and 11 are spaced apart by a distance Y. The distance Y may be up to about one foot, such as about ten inches or less, such as about six inches or less, including the household appliance 10 and 11 being in direct physical contact with each other, such as side-to-side or top-to-bottom, etc. Also by way of example, the optical transceivers 402 may be facing each other, such as one appliance, e.g., a portable appliance, may have an optical transceiver 402 positioned on or at a bottom surface thereof and oriented downwards while another appliance, e.g., a stationary appliance, may have an optical transceiver 402 positioned on or at a top surface thereof and oriented upwards. For example, in embodiments where the stationary appliance is an oven appliance, e.g., oven appliance 100 illustrated in FIGS. 2 and 3, the optical transceiver 402 may be positioned on or at cooktop 150 thereof and may be oriented upwards. Thus, in at least some embodiments, the household appliances 10 and 11 may be placed in optical communication, e.g., optical communications link 406 may be established, by placing one appliance atop the other such that the optical transceiver 402 of each appliance 10 and 11 is aligned with the optical transceiver 402 of the other appliance 10 and 11. In various embodiments, the household appliances 10 and 11 may be placed in optical communication by placing one of the new household appliance and the existing household appliance on top of the other of the new household appliance and the existing household appliance, or by placing the household appliances 10 and 11 side-by-side, and/or diagonally, e.g., at an oblique angle to each other, in order to mutually align the optical transceivers 402 thereof. For example, the household appliances 10 and 11 may be placed in any suitable alignment, e.g., based on where each optical transceiver 402 is located on each respective household appliance 10 or 11, such as on a top side, bottom side, front side, rear side, left side, or right side of one or both of the household appliances 10 and 11.

One or both of the household appliances 10 and 11 may also connect to and communicate with a remote server or database 420, e.g., via a network such as the internet 1000. The household appliances 10 and 11 may access the internet 1000 via an access point such as a modem or router 400, which may be a part of a local network, such as a WI-FI® network, e.g., in a user's home. The household appliances 10 and/or 11 may be in communication with the router 400 through various possible communication connections and interfaces, such as but not limited to Zigbee, BLUETOOTH®, WI-FI®, or any other suitable communication connection.

Methods and systems according to the present disclosure advantageously provide a smoother and more convenient user experience when commissioning or provisioning a new household appliance. For example, commissioning the new appliance may include connecting the new appliance(s) to a WI-FI® network for the first time and/or adding the appliance or appliances to a user account on the remote database 420. In various embodiments, the new appliance may be a portable appliance or a stationary appliance. For example, in FIG. 4, the first appliance 10 is the new appliance, whereas in FIG. 5 the second appliance 11 is the new appliance.

FIG. 4 provides a schematic view of the new household appliance or first household appliance 10 directly connected to the existing household appliance or second household appliance 11 via optical communications link 406, while the second household appliance 11 is connected to router 400 and, via router 400, to internet 1000, remote user interface device 410, and remote database 420. Thus, the first household appliance 10 may be a new household appliance and the second household appliance 11 may be an existing or already-commissioned appliance which is already logged into and connected to the home wireless network (e.g., via router 400) and commissioned to a user account on the remote database 420. Alternatively, e.g., as illustrated in FIG. 5, the first appliance 10 may be the existing appliance that is already logged into and connected to the home wireless network (e.g., via router 400) and commissioned to the user account on the remote database 420.

Also as illustrated in FIGS. 4 and 5, one or both of the appliances 10 and 11 may further be in communication, e.g., in wireless communication via internet 1000 and/or local network (such as via router 400, such as over a WI-FI connection) or via a direct wireless connection, such as BLUETOOTH, with a remote user interface device 410, and the remote user interface device 410 may, in turn, be in communication with the remote database 420, e.g., via the internet 1000. The remote user interface device 410 may be a laptop computer, smartphone, tablet, personal computer, wearable device, smart home system, and/or various other suitable devices. The remote user interface device 410 is “remote” at least in that it is spaced apart from and not physically connected to the appliances 10 and 11, e.g., the remote user interface device 410 is a separate, stand-alone device from the appliances 10 and 11 which communicates with the appliance(s) 10 and/or 11 wirelessly, in contrast to the local user interface that is built-in to each appliance 10 and 11, such as user interface panel 160 of oven appliance 100 or inputs 206/208 of coffee maker 200. Any suitable device separate from the appliances 10 and 11 that is configured to provide and/or receive communications, information, data, or commands from a user may serve as the remote user interface device 410, such as a smartphone (e.g., as illustrated in FIGS. 4 and 5), smart watch, personal computer, smart home system, or other similar device. For example, the remote user interface device 410 may be a smartphone operable to store and run applications, also known as “apps,” and some or all of the method steps disclosed herein may be performed by a smartphone app.

The remote user interface device 410 may include a memory for storing and retrieving programming instructions. Thus, the remote user interface device 410 may provide a remote user interface which may be an additional user interface to the local user interface. For example, the remote user interface device 410 may be a smartphone operable to store and run applications, also known as “apps,” and the remote user interface may be provided as a smartphone app.

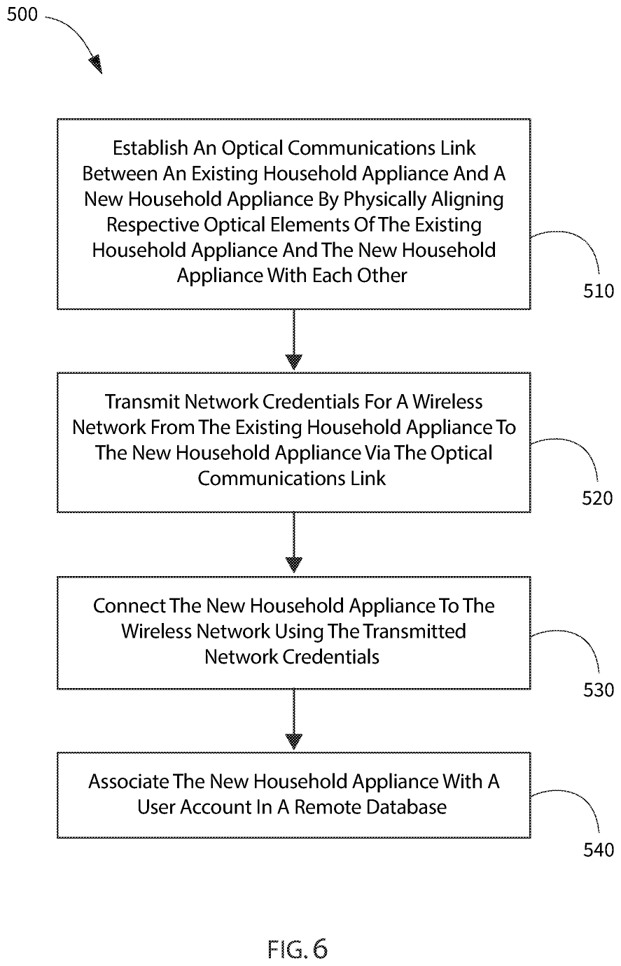

Exemplary methods according to the present subject matter include the method 500 illustrated in FIG. 6. As illustrated in FIG. 6, in some embodiments, an example method 500 of commissioning a new household appliance, such as one of the example household appliances 10 and 11, may be performed using an existing household appliance, such as the other of example household appliances 10 and 11. In some embodiments, the existing household appliance may be connected to a wireless network and commissioned to a user account.

In some embodiments, the method 500 may include a step 510 of establishing an optical communications link between the existing household appliance and the new household appliance. For example, establishing the optical communications link may include physically aligning respective optical elements, e.g., optical transceivers 402, of the existing household appliance and the new household appliance with each other. Thus, at least one of the new household appliance and the existing household appliance may be a portable appliance, as described above, such that the portable appliance may be physically moved into alignment with the other appliance. The optical elements may each define a range over which the optical element can reliably transmit an optical signal, and a field of view within which the optical element can receive an optical signal. Thus, physically aligning the optical elements of the existing household appliance and the new household appliance may include positioning the existing household appliance and the new household appliance such that the respective optical elements of each household appliance are in range and in view of each other. For example, such alignment may include picking up and/or moving one of the existing household appliance and the new household appliance, e.g., at least one of the existing household appliance and the new household appliance may be a portable appliance, as described above.

In some embodiments, the method 500 may also include a step 520 of transmitting network credentials, such as an SSID and password, for the wireless network from the existing household appliance to the new household appliance via the optical communications link. The new household appliance may then connect to the wireless network, e.g., method 500 may include a step 530 of connecting, by the new household appliance, to the wireless network using the transmitted network credentials.

The new household appliance may be in communication with the remote database via the wireless network (and without connecting through the existing household appliance at this point, e.g., without using the existing household appliance as a relay or other intermediary for connecting the new household appliance to the wireless network or remote database). User account information, such as a user name or ID and password, may also be sent over the optical communications link, e.g., transmitted by the existing household appliance and received by the new household appliance. Thus, method 500 may also include a step 540 of associating the new household appliance with the user account in a remote database. For example, the new household appliance may communicate with the remote database as mentioned, and may employ the user account information received from the existing household appliance via the optical communications link to update the user account in the remote database by adding the new household appliance to the user account.

In some embodiments, the method 500 may include additional verification steps. For example, the existing appliance may notify the remote database (which may be, in various exemplary embodiments, hosted in the cloud or in a distributed computing environment, etc.) of the new appliance to be commissioned. Such notice may be or include, for example, a commissioning request. In some embodiments, the method 500 may include sending a commissioning request for the new household appliance to the remote database from the existing household appliance. In some embodiments, the commissioning request may be sent by the existing household appliance after establishing the optical communications link. For example, the existing household appliance may receive identifying information, such as a model name, model number, household appliance type, serial number, and/or other suitable identifying information of the new household appliance from the new household appliance via the optical communications link. The commissioning request transmitted by the existing household appliance may thus include an identity of the new household appliance and thereby notify the remote database of the new appliance to be commissioned.

The commissioning request may then be validated by the remote database. In some embodiments, the remote database may send an approval request for approval to commission the new household appliance. For example, the approval request may be sent to a remote user interface device, e.g., remote user interface device 410 as described above. User approval may then be received by the remote user interface device, such as a notification or pop-up on a smartphone requesting approval to commission the new household appliance, which the user then selects, e.g., touches on a touchscreen of the remote user interface device, an affirmative response to approve commissioning the new household appliance. As another example, the approval request may be audible, e.g., a spoken notification from a smart speaker, and the affirmative response may be a verbal, spoken, response from the user. The remote user interface device may then, upon receipt of the user approval, e.g., affirmative response to the commissioning request, transmit the user approval to the existing household appliance, such as to the remote database and from the remote database to the existing household appliance. The user approval may be transmitted to and received by the existing household appliance prior to transmitting the network credentials to the new household appliance.

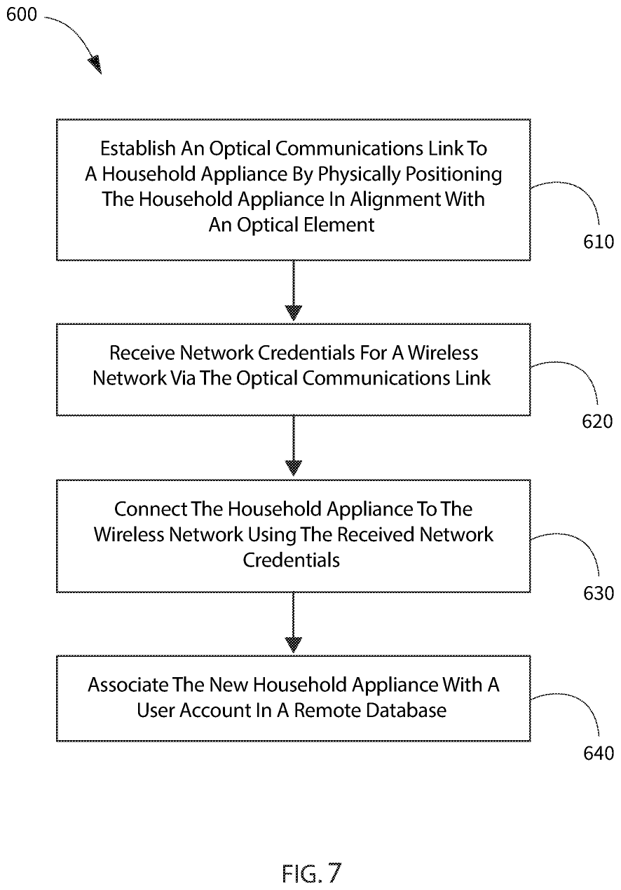

Additional exemplary methods according to the present subject matter include the method 600 illustrated in FIG. 7. As illustrated in FIG. 7, in some embodiments, an example method 600 of commissioning a household appliance, such as one of the example household appliances 10, 11, 100, and/or 200, may include a step 610 of establishing an optical communications link to the household appliance by physically positioning the household appliance in alignment with an optical element. For example, the household appliance may include an optical element, such as an optical transceiver, e.g., an infrared (IR) transceiver, and the household appliance may be positioned in alignment with the optical element (which is also generally the same or compatible optical element, e.g., transceiver, etc., as the optical element of the household appliance) by locating and orienting the household appliance such that the household appliance, e.g., the optical element thereof, is within a range of and within a field of view of the optical element in order to establish the optical communications link. The optical element with which the household appliance is aligned may be an optical element of another household appliance, e.g., the household appliance may be a new household appliance, and establishing the optical communications link may include establishing the optical communications link between the new household appliance and an existing household appliance already connected to the wireless network and commissioned to the user account. The optical element with which the household appliance is aligned may also be an optical element of another device other than a household appliance, such as a remote user interface device, that is already connected to the wireless network.

Method 600 may, in some embodiments, further include a step 620 of receiving network credentials, by the household appliance, via the optical communications link, e.g., from the existing household appliance, remote user interface device, or other suitable device with which the household appliance was aligned and optically coupled in step 610. Embodiments of the network credential receiving step 620 may be similar to those described above at step 520 in method 500. The new household appliance may then connect to the wireless network, e.g., method 600 may include a step 630 of connecting, by the new household appliance, to the wireless network using the transmitted network credentials.

In some embodiments, the method 600 may also include a step 640 of associating the household appliance with a user account in a remote database. The household appliance may be in communication with the remote database via the wireless network, and, having received user account information over the optical communications link, the household appliance may employ the user account information to update the user account in the remote database by adding the new household appliance to the user account.

Further, method 600 may also include one or more additional verification steps, such as notifying the remote database of the household appliance to be commissioned, validating the commissioning request, and receiving user approval of the commissioning request. Such steps may be similar to those described above with reference to method 500.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method of commissioning a new household appliance using an existing household appliance, the existing household appliance connected to a wireless network and commissioned to a user account, the method comprising:
establishing an optical communications link between the existing household appliance and the new household appliance by physically aligning respective optical elements of the existing household appliance and the new household appliance with each other;
transmitting network credentials for the wireless network from the existing household appliance to the new household appliance via the optical communications link;
connecting, by the new household appliance, to the wireless network using the transmitted network credentials; and
associating the new household appliance with the user account in a remote database.

2. The method of claim 1, further comprising sending, from the existing household appliance, a commissioning request for the new household appliance to the remote database after establishing the optical communications link.

3. The method of claim 2, further comprising validating the commissioning request by the remote database.

4. The method of claim 1, further comprising receiving user approval prior to transmitting the network credentials.

5. The method of claim 4, further comprising sending an approval request from the remote database to a remote user interface device after establishing the optical communications link.

6. The method of claim 4, wherein the user approval is received by the existing household appliance from a remote user interface device.

7. The method of claim 1, further comprising:
sending an approval request from the remote database to a remote user interface device;
receiving, by the remote database, user approval from the remote user interface device in response to the approval request; and
notifying the existing household appliance, by the remote database, of the user approval prior to transmitting the network credentials.

8. The method of claim 1, wherein at least one of the new household appliance and the existing household appliance is a portable appliance.

9. The method of claim 1, wherein establishing the optical communications link comprises placing one of the new household appliance and the existing household appliance on top of the other of the new household appliance and the existing household appliance.

10. A method of commissioning a household appliance, the method comprising:
establishing an optical communications link to the household appliance by physically positioning the household appliance in alignment with an optical element;
receiving network credentials, by the household appliance, via the optical communications link;
connecting, by the household appliance, to a wireless network using the received network credentials; and
associating the household appliance with a user account in a remote database.

11. The method of claim 10, wherein the household appliance is a new household appliance, wherein the step of establishing the optical communications link comprises establishing the optical communications link between the new household appliance and an existing household appliance already connected to the wireless network and commissioned to the user account.

12. The method of claim 11, wherein the step of receiving the network credentials via the optical communications link comprises transmitting the network credentials from the existing household appliance to the new household appliance via the optical communications link.

13. The method of claim 11, further comprising sending, from the existing household appliance, a commissioning request for the new household appliance to the remote database after establishing the optical communications link.

14. The method of claim 13, further comprising validating the commissioning request by the remote database.

15. The method of claim 10, further comprising receiving user approval prior to receiving the network credentials.

16. The method of claim 15, further comprising sending an approval request from the remote database to a remote user interface device after establishing the optical communications link.

17. The method of claim 15, wherein the user approval is received from a remote user interface device.

18. The method of claim 10, further comprising:
sending an approval request from the remote database to a remote user interface device; and
receiving, by the remote database, user approval from a remote user interface device in response to the approval request prior to receiving the network credentials.

19. The method of claim 10, wherein the household appliance is a portable appliance.

20. The method of claim 10, wherein the household appliance is a first household appliance, wherein establishing the optical communications link comprises placing the household appliance in physical contact with a second household appliance.
